(19) United States
(12) Patent Application Publication
(10) Pub. No.: US 2013/0330989 A1
(43) Pub. Date: Dec. 12, 2013

(54) COMPOSITE SHEET, METHOD FOR PREPARING THE SAME, AND DISPLAY SUBSTRATE INCLUDING THE SAME

(71) Applicants: Sung Han IM, Uiwang-si (KR); Young Kwon KIM, Uiwang-si (KR); Seok Won CHOI, Uiwang-si (KR); Sang Keol LEE, Uiwang-si (KR); Eun Hwan JEONG, Uiwang-si (KR); Woo Jin LEE, Uiwang-si (KR)

(72) Inventors: Sung Han IM, Uiwang-si (KR); Young Kwon KIM, Uiwang-si (KR); Seok Won CHOI, Uiwang-si (KR); Sang Keol LEE, Uiwang-si (KR); Eun Hwan JEONG, Uiwang-si (KR); Woo Jin LEE, Uiwang-si (KR)

(21) Appl. No.: 13/915,975

(22) Filed: Jun. 12, 2013

(30) Foreign Application Priority Data
Jun. 12, 2012 (KR) 10-2012-0062916

(51) Int. Cl. C08K 3/40

(52) U.S. Cl. CPC C08K 3/40
USPC 442/1; 524/588; 442/180; 427/387

(57) ABSTRACT

A composite sheet includes a matrix and a reinforcing material impregnated in the matrix. The composite sheet has a weight variation (ΔW) of about 98% or more at 350° C. and a relaxation modulus of about 1000 MPa or less under a load of 100 μN.

### CROSS-REFERENCE TO RELATED APPLICATION

Korean Patent Application No. 10-2012-0062916 filed on Jun. 12, 2012, in the Korean Intellectual Property Office, and entitled: “COMPOSITE SHEET, METHOD FOR PREPARING THE SAME, AND DISPLAY SUBSTRATE INCLUDING THE SAME,” is incorporated by reference herein in its entirety.

### BACKGROUND

1. Field

Embodiments relate to a composite sheet, a method for preparing the same, and a display substrate including the same.

2. Description of the Related Art

A glass substrate has excellent thermal resistance, transparency and a low coefficient of linear expansion. Therefore, a glass substrate has been widely used as a substrate for liquid crystal display devices, organic EL display devices, color filters, solar cells, etc. However, glass substrates are limited in applicability to thinner and lighter liquid crystal displays due to thickness, weight and vulnerability to impact. Moreover, due to brittleness of glass materials, a glass substrate may not be suitable for such display substrates.

### SUMMARY

Embodiments are directed to a composite sheet including a matrix, and a reinforcing material impregnated in the matrix. The composite sheet has a relaxation modulus of about 1000 MPa or less under a load of 100 μN and a weight variation (ΔW) of about 98% or more at 350° C. according to Equation 1:

$$Δ W = \frac{Wa}{W b} \times 100 , \qquad [ Equation 1 ]$$

wherein Wa is a sample weight as measured after heating 50 mg of a sample from 25° C. to 350° C. at a temperature increasing rate of 5° C./min in a nitrogen atmosphere by thermogravimetric analysis (TGA/DSC1), and Wb is an initial weight of the sample at 25° C.

The matrix may include a silicone resin containing a cyclic siloxane.

The matrix may include a reaction product of a cyclic siloxane and a linear terminal vinyl group-containing polysiloxane.

The cyclic siloxane may be represented by Formula 1:

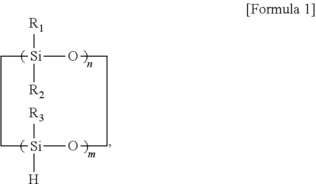

wherein R₁, R₂ and R₃ in Formula 1 are each independently hydrogen, a substituted or unsubstituted C1-C5 alkyl group, or a substituted or unsubstituted C6-C12 aryl group; n and m are each an integer from 0 to 6; and n+m is an integer from 3 to 6.

The linear terminal vinyl group-containing polysiloxane may include a compound represented by Formula 2:

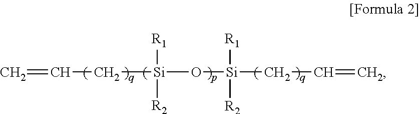

wherein R₁ and R₂ in Formula 2 are each independently hydrogen, a substituted or unsubstituted C1-C5 alkyl group, or a substituted or unsubstituted C6-C12 aryl group; p is an integer from 1 to 20; and q is an integer from 0 to 20.

The reaction product may be of the cyclic siloxane and the linear terminal vinyl group-containing polysiloxane in a mole-equivalent ratio of about 0.5:1 to about 2.5:1.

The composite sheet may have a weight variation (ΔW) of about 98% or more at 350° C. according to Equation 1:

$$Δ W = \frac{Wa}{W b} \times 100 ,$$

wherein Wa is a sample weight as measured after heating 50 mg of a sample from 25° C. to 350° C. at a temperature increasing rate of 5° C./min in a nitrogen atmosphere by thermogravimetric analysis (TGA/DSC1), and Wb is an initial weight of the sample at 25° C.

The composite sheet may have a transmittance of about 90% or more at a wavelength of 550 nm.

The composite sheet may have a bending resistance of less than about 5 mm according to ASTM D522, and a coefficient of thermal expansion (CTE) of less than about 10 ppm/K.

The reinforcing material may include at least one of a glass fiber cloth, a glass fabric, a non-woven glass fabric, and a glass mesh.

Embodiments are also directed to a method for preparing a composite sheet. The method includes: preparing a matrix composition including a cyclic siloxane and a linear terminal vinyl group-containing polysiloxane, impregnating the matrix composition with a reinforcing material and then curing the same.

Embodiments are also directed to a display substrate including the composite sheet.

### BRIEF DESCRIPTION OF DRAWINGS

Features will become apparent to those of skill in the art by describing in detail exemplary embodiments with reference to the attached drawings in which:

FIG. 1 illustrates a schematic sectional view of a composite sheet according to an embodiment.

FIG. 2 illustrates a schematic diagram of a bond form of a cyclic siloxane and a linear terminal vinyl group-containing polysiloxane.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration.

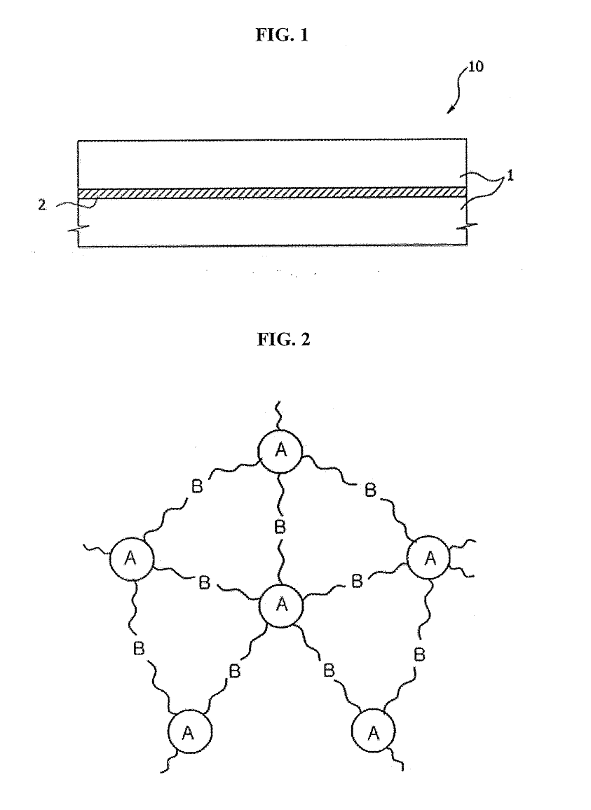

FIG. 1 is a schematic sectional view of a composite sheet according to an embodiment. Referring to FIG. 1, a composite sheet 10 according to the embodiment includes a matrix 1 that includes a reinforcing material 2. According to the embodiment, the reinforcing material 2 may have a laminated structure, as an example. The reinforcing material may be impregnated in a matrix as a support. In another implementation, the reinforcing material may be dispersed in the matrix. In another implementation, the reinforcing material may have a woven structure and may be impregnated in the matrix. In another implementation, the reinforcing material may be arranged in a single direction and may be impregnated in the matrix. The reinforcing material may be in the form of a single layer or in the form of multiple layers.

In one implementation, the matrix may include a silicone resin containing a cyclic siloxane.

In one implementation, the matrix may include a reaction product of a cyclic siloxane and a linear terminal vinyl group-containing polysiloxane.

According to an embodiment, a method for preparing the composite sheet may include: preparing a matrix composition including a cyclic siloxane and a linear terminal vinyl group-containing polysiloxane, and impregnating the matrix composition with a reinforcing material and then curing the same.

FIG. 2 is a schematic diagram illustrating a bond form of a cyclic siloxane and a linear terminal vinyl group-containing polysiloxane. Hydrogen of the cyclic siloxane reacts with a vinyl group of the linear terminal vinyl group-containing polysiloxane, so that the linear terminal vinyl group-containing polysiloxane (B) is bonded between the cyclic siloxane moieties (A). For example, the linear terminal vinyl group-containing polysiloxane (B) may form a cross-link between cyclic siloxane moieties (A).

The cyclic siloxane may be represented by Formula 1:

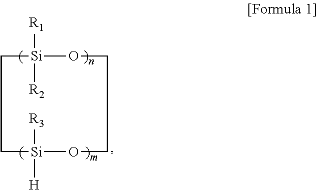

wherein R₁, R₂, and R₃ in Formula 1 are each independently hydrogen, a substituted or unsubstituted C1-C5 alkyl group, or a substituted or unsubstituted C6-C12 aryl group; n and m are each an integer from 0 to 6; and n+m is an integer from 3 to 6. The oxygen atoms are bonded to silicon and are not directly bonded to each other.

In one implementation, when m is 0, any one of R₁ and R₂ may be hydrogen.

As used herein, the term “substituted” denotes that at least one hydrogen atom is substituted with a halogen atom, a hydroxyl group, an amino group, a carbonyl group, a thiol group, an ester group, an ether group, a carboxyl group or a salt thereof, a sulfonate group or a salt thereof, a phosphate group or a salt thereof, a C1-C20 alkyl group, a C2-C20 alkenyl group, a C2-C20 alkynyl group, a C1-C20 alkoxy group, a C6-C30 aryl group, a C6-C30 aryloxy group, a C3-C30 cycloalkyl group, a C3-C30 cycloalkenyl group, a C3-C30 cycloalkenyl group, or a combination thereof.

Examples of the cyclic siloxane may include tetramethylcyclotetrasiloxane, tetraethylcyclotetrasiloxane, tetrapropylcyclotetrasiloxane, tetrabutylcyclotetrasiloxane, pentamethylcyclopentasiloxane, pentaethylcyclopentasiloxane, hexamethylcyclohexasiloxane or the like.

The linear terminal vinyl group-containing polysiloxane may be a linear siloxane having vinyl groups at terminals thereof, and may contain the vinyl groups within a range that satisfies an equivalent ratio. For example, the vinyl groups may be present in an amount of about 25 mol % to about 50 mol % in the matrix composition. Within this range, high curing efficiency and rubbery properties after curing may be obtained.

In one embodiment, the linear terminal vinyl group-containing polysiloxane may be represented by Formula 2:

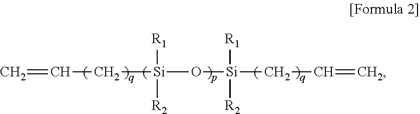

wherein R₁ and R₂ in Formula 2 are each independently hydrogen, a substituted or unsubstituted C1-C5 alkyl group, or a substituted or unsubstituted C6-C12 aryl group; p is an integer from 1 to 20; and q is an integer from 0 to 20.

For example, DMS-V03, V05, V21 (vinyl-terminated polydimethylsiloxysilane, manufactured by Gelest, Inc.), or the like may be used as the linear terminal vinyl group-containing polysiloxane.

In one embodiment, the linear terminal vinyl group-containing polysiloxane may have a weight average molecular weight of about 100 g/mol to about 10,000 g/mol. Within this range, the matrix composition may exhibit outstanding properties in terms of thermal stability, transparency, and bending resistance. For example, the linear terminal vinyl group-containing polysiloxane may have a weight average molecular weight from about 200 g/mol to about 5,000 g/mol, for example, from about 300 g/mol to about 1,000 g/mol, or, for example, from about 350 g/mol to about 700 g/mol. The weight average molecular weight may be measured by GPC (gel permeation chromatography).

According to embodiments, the mechanical properties of the composite sheet may be controlled by controlling the weight average molecular weight of the linear terminal vinyl group-containing polysiloxane.

In one implementation, the cyclic siloxane and the linear terminal vinyl group-containing polysiloxane may be present in a mole-equivalent ratio of about 0.5:1 to about 2.5:1. Within this range of the mole-equivalent ratio, the matrix composition may have a high curing efficiency. For example, the cyclic siloxane and the linear terminal vinyl group-containing polysiloxane may be present in a mole-equivalent ratio of about 1.0:1 to about 2.0:1. The mole-equivalent ratio is a mole ratio of the Si—H group in the cyclic siloxane to the vinyl groups in the linear terminal vinyl group-containing polysiloxane.

The matrix composition may further include typical additives such as catalysts, inhibitors, etc.

The reinforcing material may include at least one of a glass fiber cloth, a glass fabric, a non-woven glass fabric, and a glass mesh. For example, the reinforcing material may include a glass fiber cloth.

A difference in indexes of refraction between the reinforcing material and the matrix may be about 0.01 or less. Within this range, the matrix composition may exhibit excellent transparency. For example, the difference in indexes of refraction therebetween may be about 0.0001 to about 0.007.

A method for preparing a composite sheet may include impregnating the matrix composition with the reinforcing material, placing the matrix composition between release films, and laminating the same, and curing the matrix composition.

A composite sheet according to embodiments may include the matrix composition and the reinforcing material in a weight ratio of about 70:30 to about 95:5, for example, from about 80:20 to about 90:10. Within this range, the composite sheet may have properties suited for a display substrate.

As used herein, the term “impregnate” and derivatives thereof may include forming a single layer or multilayer structure of the reinforcing material in the matrix.

Curing may be performed at a temperature from about 40° C. to about 120° C., for example, from about 50° C. to about 100° C., for about 0.1 minutes to about 10 hours, or, for example, for about 30 minutes to about 5 hours. Within this range, sufficient curing of the matrix and the reinforcing material may be secured while providing high mechanical strength.

A composite sheet according to embodiments may have a thickness of about 15 μm to about 200 μm. Within this range, the composite sheet may be used for display substrates.

In one embodiment, the matrix composition may have a glass transition temperature from about −40° C. to about −20° C. In this case, within a temperature range from room temperature to 80° C., that is, within the operation temperature range when used for a display substrate, the composite sheet may have excellent flexibility and stiffness, as well as a low coefficient of thermal expansion.

The composite sheet may have a weight change (ΔW) of about 98% or more at 350° C. For example, the weight change (ΔW) may be from about 98.5% to about 99.9%. The weight change (ΔW) is calculated according to Equation 1:

$$Δ W = \frac{Wa}{W b} \times 100 , \qquad [ Equation 1 ]$$

wherein Wa is a sample weight, as measured after heating 50 mg of a sample from 25° C. to 350° C. at a temperature increasing rate of 5° C./min in a nitrogen atmosphere, as determined by thermogravimetric analysis (TGA/DSC1), and Wb is an initial weight of the sample at 25° C.

The composite sheet may have a relaxation modulus of about 1000 MPa or less, for example, about 10 MPa to about 200 MPa, or, for example, about 20 Mpa to about 150 MPa, under a load of 100 μN. In one implementation, the composite sheet may have relaxation modulus of about 20 Mpa to about 100 MPa.

The composite sheet may have a transmittance of about 90% or more, for example about 90% to about 99%, at a wavelength of 550 nm.

The composite sheet may have a bending resistance of less than about 5 mm, for example, from about 0.1 mm to about 3.5 mm, as determined according to ASTM D522, and a coefficient of thermal expansion (CTE) of less than about 10 ppm/K, for example, from about 0.1 to about 5 ppm/K.

In another implementation, the composite sheet may further include a smoothing layer, a gas barrier layer or the like on at least one side thereof. A process of forming these layers may be readily performed by those skilled in the art.

Another aspect relates to a display substrate including the composite sheet. The display substrate may be used as a substrate for display and optical devices, such as liquid crystal display devices (LCDs), color filters, organic EL display devices, solar cells, touch screen panels, etc.

The following Examples and Comparative Examples are provided in order to highlight characteristics of one or more embodiments, but it is to be understood that the Examples and Comparative Examples are not to be construed as limiting the scope of the embodiments, nor are the Comparative Examples to be construed as being outside the scope of the embodiments. Further, it is to be understood that the embodiments are not limited to the particular details described in the Examples and Comparative Examples.

### EXAMPLES

### Example 1

Tetramethylcyclotetrasiloxane and a linear vinyl-terminal polyorganosiloxane DMS-V03 (MW 500, DP 5, Gelest Inc.) were blended in an equivalent ratio of 2:1 and sufficiently mixed using a vortex mixer. After impregnating the mixture with D-glass based glass fibers (Product 3313, Nittobo Co. Ltd.), the impregnated glass fibers were placed on a release glass substrate and left at room temperature for 24 hours until the viscosity was increased. Then, with an upper surface of the impregnated glass fibers covered with a glass substrate, the remaining resin was removed from the glass fibers using a laminator, followed by heat curing in an oven at 100° C. for 4 hours, thereby producing a transparent silicone composite sheet.

### Example 2

A silicon composite sheet was prepared in the same manner as in Example 1 except that DMS-05 (MW 800, DP 9, Gelest Inc.) was used as the vinyl-terminal polyorganosiloxane instead of DMS-V03.

### Example 3

A silicon composite sheet was prepared in the same manner as in Example 1 except that DMS-V21 (MW 6000, DP 65, Gelest Inc.) was used as the vinyl-terminal polyorganosiloxane instead of DMS-V03.

### Comparative Example 1

After blending part A and part B of Sylgard 184, which is a polyorganosiloxane manufactured by Dow Corning Co., in a weight ratio of 1:10, the mixture was sufficiently mixed using a vortex mixer. After impregnating the mixture with E-glass based glass fibers (Product name 3313, Nittobo Co. Ltd.), the impregnated glass fibers were placed between two release glass substrates. Then, remaining resin was removed from the glass fibers using a laminator, followed by heat curing in an oven at 100° C. for 4 hours, thereby producing a transparent silicone composite sheet.

### Comparative Example 2

A silicon composite sheet was prepared in the same manner as in Example 1 except that tetravinyltetramethylcyclotetrasiloxane was used as the vinyl-terminal polyorganosiloxane.

The composite sheets prepared in Examples and the Comparative Examples were evaluated as to the following properties, and results are shown in Table 1.

Property Evaluation

(1) Thermal stability: After loading 50 mg of a sample in a thermogravimetric analysis tester TGA/DSC1 (Mettler Toledo Inc.), weight loss of the sample was measured by heating the sample from 25° C. to 350° C. at a temperature increasing rate of 5° C./min in a nitrogen atmosphere. An initial weight and each weight of the sample at 250° C., 300° C. and 350° C. were measured, and a weight change (ΔW) of the sample was calculated according to Equation 1:

$$Δ W = \frac{Wa}{W b} \times 100 , \qquad [ Equation 1 ]$$

wherein Wa is a sample weight, as measured after heating 50 mg of a sample from 25° C. to 350° C. at a temperature increasing rate of 5° C./min in a nitrogen atmosphere using a thermogravimetric analyzer TGA/DSC1, and Wb is an initial weight of the sample at 25° C.

(2) Relaxation modulus: Relaxation modulus was measured using a Triboindentor (Hysitron Co.) in a 100 μN force-control mode at room temperature (unit: MPa).

(3) Transmittance (%): Transmittance was measured using a UV-Vis spectrometer V-550 (JASCO Instrument) at a wavelength of 550 nm.

(4) Bending resistance (mm): After winding the composite sheet cut into a width of 1 cm around an SUSS cylinder having a diameter of 0.5 mm to 10 mm and applying a force of 1 kg for 1 minute to the composite sheet according to ASTM D522, bending resistance was measured by observing damage to the composite sheet using a microscope.

(5) CTE (ppm/K): CTE was measured using a thermomechanical analyzer model Q400 (TA Instruments Inc.) in a tensile mode while heating the sample from −10° C. to 300° C. at a temperature increasing rate of 5° C./min.

TABLE 1

| | TGA result | | | | | | |
|---|---|---|---|---|---|---|---|
| | ΔW % | ΔW % | ΔW % | Modulus | | Bending | |
| | at 250° C. | at 300° C. | at 350° C. | [MPa] | Transmittance | resistance | CTE |
| Example 1 | 99.70 | 99.70 | 99.67 | 86 | 90% | 3.0 mm | 5 |
| Example 2 | 99.53 | 99.20 | about 98.69 | 68 | 90% | 3.0 mm | 5 |
| Example 3 | 99.29 | 99.01 | about 98.68 | 23 | 90% | 3.0 mm | 5 |
| Comparative | 99.49 | about 98.93 | 97.92 | 803 | 44% | 10.0 mm | 5 |
| Example 1 | | | | | | | |
| Comparative | 99.82 | 99.80 | 99.75 | 7300 | 85% | 15.0 mm | 13 |
| Example 2 | | | | | | | |

As shown in Table 1, it can be seen that the composite sheets prepared in Examples 1 to 3 exhibited outstanding properties in terms of thermal stability, transmittance, bending resistance and coefficient of thermal expansion. On the other hand, it can be seen that the composite sheet of Comparative Example 1 had less desirable properties in terms of thermal stability, transmittance and bending resistance as compared with the composite sheets of Examples 1 to 3. Further, it can be seen that the composite sheet prepared in Comparative Example 2 had good thermal stability, but exhibited less desirable properties in terms of transmittance, bending resistance and coefficient of thermal expansion as compared with the composite sheets of Examples 1 to 3. Particularly, it can be seen that the composite sheet prepared in Comparative example 2 had a high coefficient of thermal expansion, and making it less suitable for a display substrate.

By way of summation and review, a display substrate made of a plastic optical film material is attracting attention as an alternative to glass substrates in the art. However, a plastic optical film material may have a high coefficient of thermal expansion and may be disadvantageous in terms of stiffness. A method for preparing a transparent substrate having improved stiffness may be carried out by impregnating a reinforcing material including glass fibers or glass cloths into a polymeric matrix resin.

Recently, a method for preparing a transparent substrate having a low coefficient of thermal expansion by impregnating a reinforcing material into a rubbery material has been proposed. Among these materials, linear polyorganosiloxane resins have been focus of attention. A transparent substrate made of the linear polyorganosiloxane resin has excellent properties in terms of transparency, flexibility and the like, and is lightweight. However, although the linear polyorganosiloxane resin has been applied to various industrial fields due to various advantages such as excellent curing, chemical stability, etc., the linear polyorganosiloxane resin is known to decompose and form a volatile ring-shaped cyclotrisiloxane at temperatures of 250° C. or more. Thus, a linear polyorganosiloxane resin may have limiting applicability as a substrate material.

Various attempts have been made to increase the thermal stability of silicone resins. For example, a silicone resin having improved heat resistance may be prepared by reacting 1,3,5,7-tetramethylcyclotetrasiloxane with 1,3,5,7-tetravinyl-1,3,5,7-tetramethylcyclotetrasiloxane. A silicone resin having improved heat resistance may beprepared by reacting 1,3,5,7-tetravinyl-1,3,5,7-tetramethylcyclotetrasiloxane with 1,4-bis(dimethylsilyl)benzene.

However, despite the advantage of increased heat resistance, these resins may have disadvantages of reduced flexibility and brittleness. As the degree of cross-linking of a silicon matrix increases, the formation of cyclotrisiloxane can be inhibited. However, the silicone resins may be changed from a rubbery phase to a glassy phase, thereby causing the aforementioned disadvantages.

In contrast, embodiments provide a composite sheet that has outstanding properties in term of heat resistance, thermal stability, flexibility, mechanical properties, and optical properties to be suited for display substrates, and that may be applied to smaller, thinner, lighter and cheaper display substrates. In addition, embodiments provide a method for preparing the composite sheet, and a display substrate using the same. The composite sheet according to embodiments may suppress deformation of a ring structure and decomposition even at a high temperature of 350° C. or more, thereby preventing failure of materials at high temperature in manufacture of a substrate.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope thereof as set forth in the following claims.

What is claimed is:

1. A composite sheet, comprising: a matrix and a reinforcing material impregnated in the matrix, the composite sheet having a relaxation modulus of about 1000 MPa or less under a load of 100 μN and a weight variation (ΔW) of about 98% or more at 350° C. according to Equation 1:
$$Δ W = \frac{Wa}{W b} \times 100 , \qquad [ Equation 1 ]$$
wherein Wa is a sample weight as measured after heating 50 mg of a sample from 25° C. to 350° C. at a temperature increasing rate of 5° C./min in a nitrogen atmosphere by thermogravimetric analysis (TGA/DSC1), and Wb is an initial weight of the sample at 25° C.

2. The composite sheet as claimed in claim 1, wherein the matrix includes a silicone resin including a cyclic siloxane.

3. The composite sheet as claimed in claim 2 wherein the cyclic siloxane includes a compound represented by Formula 1: 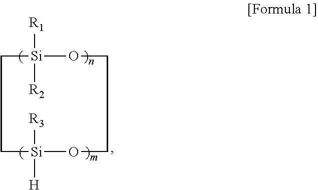
wherein R₁, R₂ and R₃ in Formula 1 are each independently hydrogen, a substituted or unsubstituted C1-C5 alkyl group, or a substituted or unsubstituted C6-C12 aryl group; n and m are each an integer from 0 to 6; and n+m is an integer from 3 to 6.

4. The composite sheet as claimed in claim 1, wherein the matrix includes a reaction product of a cyclic siloxane and a linear terminal vinyl group-containing polysiloxane.

5. The composite sheet as claimed in claim 4, wherein the cyclic siloxane comprises a compound represented by Formula 1: 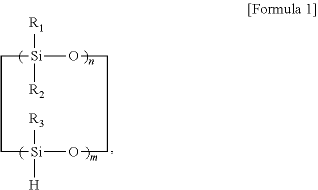
wherein R₁, R₂ and R₃ in Formula 1 are each independently hydrogen, a substituted or unsubstituted C1-C5 alkyl group, or a substituted or unsubstituted C6-C12 aryl group; n and m are each an integer from 0 to 6; and n+m is an integer from 3 to 6.

6. The composite sheet as claimed in claim 4, wherein the linear terminal vinyl group-containing polysiloxane includes a compound represented by Formula 2: 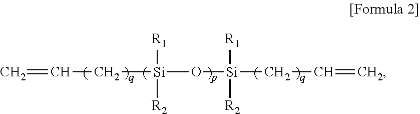
wherein R₁ and R₂ in Formula 2 are each independently hydrogen, a substituted or unsubstituted C1-C5 alkyl group, or a substituted or unsubstituted C6-C12 aryl group; p is an integer from 1 to 20; and q is an integer from 0 to 20.

7. The composite sheet as claimed in claim 4, wherein the reaction product is of the cyclic siloxane and the linear terminal vinyl group-containing polysiloxane in a mole-equivalent ratio of about 0.5:1 to about 2.5:1.

8. The composite sheet as claimed in claim 1, having a transmittance of about 90% or more at a wavelength of 550 nm.

9. The composite sheet as claimed in claim 1, having a bending resistance of less than about 5 mm according to ASTM D522, and a coefficient of thermal expansion (CTE) of less than about 10 ppm/K.

10. The composite sheet as claimed in claim 1, wherein the reinforcing material includes at least one of a glass fiber cloth, a glass fabric, a non-woven glass fabric, and a glass mesh.

11. A method for preparing a composite sheet, the method comprising:
preparing a matrix composition including a cyclic siloxane and a linear terminal vinyl group-containing polysiloxane; and
impregnating the matrix composition with a reinforcing material, followed by curing.

12. The method as claimed in claim 11, wherein the cyclic siloxane includes a compound represented by Formula 1: 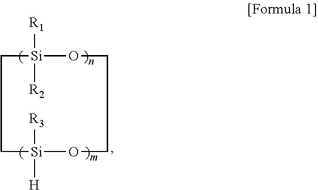
wherein R₁, R₂ and R₃ in Formula 1 are each independently hydrogen, a substituted or unsubstituted C1-C5 alkyl group, or a substituted or unsubstituted C6-C12 aryl group; n and m are each an integer from 0 to 6; and n+m is an integer from 3 to 6.

13. The method as claimed in claim 11, wherein the linear terminal vinyl group-containing polysiloxane includes a compound represented by Formula 2: 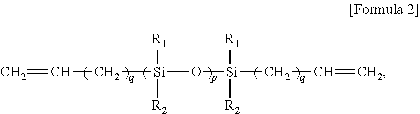
wherein R₁ and R₂ in Formula 2 are each independently hydrogen, a substituted or unsubstituted C1-C5 alkyl group, or a substituted or unsubstituted C6-C12 aryl group; p is an integer from 1 to 20; and q is an integer from 0 to 20.

14. The method as claimed in claim 11, wherein the cyclic siloxane and the linear terminal vinyl group-containing polysiloxane are present in a mole-equivalent ratio of about 0.5:1 to about 2.5:1.

15. A display substrate comprising the composite sheet as claimed in claim 1.
